(19) United States
(12) Patent Application Publication
(10) Pub. No.: US 2013/0001316 A1
(43) Pub. Date: Jan. 3, 2013

(54) Glue Applying System and Method

(75) Inventors: Yong Liu, Guangdong (CN); Jun Wang, Guangdong (CN); Shengxin Li, Guangdong (CN); Jing Wang, Guangdong (CN)

(73) Assignee: Shenzhen China Star Optoelectronics Technology Co. Ltd, Guangming District of Shenzhen (CN)

(21) Appl. No.: 13/263,152

(22) PCT Filed: Jul. 11, 2011
(86) PCT No.: PCT/CN11/77044

§ 371 Date: Oct. 6, 2011

(30) Foreign Application Priority Data
Jun. 30, 2011 (CN) 201110182193.3

(51) Int. Cl. B05B 1/30

(52) U.S. Cl. 239/1; 239/569

(57) ABSTRACT

A glue applying system and a glue applying method are disclosed. The glue applying system comprises a spray gun for spreading protective glue; a glue supplying tank for supplying the protective glue to the spray gun; a glue storing tank for furnishing the glue supplying tank with the protective glue; and a check valve connecting to the glue supplying tank and the glue storing tank, for controlling the protective glue in the glue storing tank to flow into the glue supplying tank unidirectionally. In the glue applying system and the glue applying method, coating the protective glue and supplying the protective glue to the glue supplying tank and the glue storing tank can be proceed at the same time. The glue applying system does not have to stop the coating operation while furnishing with the protective glue.

### TECHNICAL FIELD OF THE INVENTION

The present invention relates to a manufacture technique of a liquid crystal display (LCD), and more particularly, to a glue applying system and applying method thereof.

### BACKGROUND OF THE INVENTION

In LCD manufacturing processes, there is a need to coat or spread protective glue, such as moisture-proof glue, on a LCD module. Coating the protective glue on the LCD module is usually fulfilled by using a glue applying system. The glue applying system comprises a glue tank filled with the protective glue and a spray gun. The protective glue in the glue tank is spread on the LCD module by passing through the spray gun under the pressure, and thereby fulfilling a coating operation of the protective glue.

Conventional glue applying systems are classified into two types. The first type is that the glue applying system has only one glue tank. The second type is that the glue applying system has two glue tanks. For the conventional glue applying system having single glue tank, the glue tank is used to accommodate the protective glue and the protective glue is filled into the glue tank before coating. After filling the protective glue, it needs a procedure to bring out the bubbles mixed in the glue tank, manually. One can activate the glue applying system after bringing out the bubbles. When the glue applying system is working, the protective glue in the glue tank is consumed constantly. When the protective glue in the glue tank is consumed to an amount of lower bound, the glue applying system has to stop the coating operation and it needs to add the protective glue to the glue tank again. After that, it also needs to bring out the bubbles by hand. The glue applying system of this type has to be shut down when adding the protective glue to the glue tank and bringing out the bubbles, and thereby decreasing the working efficiency.

The conventional glue applying system having double glue tanks is an improvement of the conventional glue applying system having single glue tank. FIG. 1 is a schematic diagram showing a conventional glue applying system having two glue storing tanks. The conventional glue applying system comprises a base 105, a first glue tank 101, a second glue tank 102, a direction control valve 103, a spray gun 104, a first exhaust switch 1011, a second exhaust switch 1021, a first pressure switch 1012, a second pressure switch 1022, a first glue bottle 1013, and a second glue bottle 1023.

The first glue tank 101 and the second glue tank 102 are disposed on the base 105 in parallel. When the glue applying system is working, only one glue tank is used and the other glue tank stands by. The first glue bottle 1013 is removably disposed in the first glue tank 101; the second glue bottle 1023 is removably disposed in the second glue tank 102. The spray gun 104 is connected to the first glue bottle 1013 and the second glue bottle 1023 via a glue pipe and the direction control valve 103. The first exhaust switch 1011 and the first pressure switch 1012 are connected to the first glue tank 101 for releasing the gas in the first glue tank 101 or introducing the gas to the first glue tank 101. The second exhaust switch 1021 and the second pressure switch 1022 are connected to the second glue tank 102 for releasing the gas in the second glue tank 102 or introducing the gas to the second glue tank 102.

When the glue applying system shown in FIG. 1 is working and the first glue tank 101 is selected to supply the protective glue to the spray gun 104, an electronic scale on the base 105 will measure the weight of the first glue tank 101 all the time. When the weight of the first glue tank 101 reaches a lower bound, the glue applying system stops working and the direction control valve 103 automatically switches to the second glue tank 102 for supplying the protective glue to the spray gun 104 from the second glue tank 102. The first glue bottle 1013 is withdrawn and a new glue bottle filled with the protective glue is mounted on the first glue tank 101.

The above mentioned glue applying system having double glue tanks has to stop the coating operation when switching the first glue tank 101 to the second glue tank 102. This will decrease the working efficiency. In addition, there is glue remaining on the bottom of the glue bottle for every time replacing the glue bottle and this is a waste. Moreover, when replacing the glue bottle, the glue supplying pipe may be easily to mix with air and carry bubbles therein. In practice, it needs to exhaust the bubbles manually by operating the spray gun.

Therefore, it is necessary to provide another glue applying system and applying method thereof for solving the problems in the conventional skills

### SUMMARY OF THE INVENTION

The objective of the present invention is to provide a glue applying system and a glue applying method for solving the problem of low working efficiency in the conventional glue applying system.

The present invention is implemented with the following technical schemes.

A glue applying system, which comprises a spray gun for spreading protective glue, characterized in that said system further comprises:

a glue supplying tank for supplying the protective glue to the spray gun;

a glue storing tank for furnishing the glue supplying tank with the protective glue;

a check valve connecting to the glue supplying tank and the glue storing tank, for controlling the protective glue in the glue storing tank to flow into the glue supplying tank unidirectionally;

a pressure valve for controlling gas introduced to the glue storing tank when the protective glue in the glue storing tank unidirectionally flows into the glue supplying tank; and

a pressure reducing valve connecting to the glue supplying tank and the glue storing tank, for accommodating a pressure difference between the glue supplying tank and the glue storing tank, and maintaining the pressure difference between the glue supplying tank and the glue storing tank as a constant when the protective glue in the glue storing tank unidirectionally flows into the glue supplying tank.

In one embodiment of the present invention, the glue applying system further comprises a first sensor and a second sensor. The first sensor is utilized for detecting a remaining amount of the protective glue in the glue supplying tank and sending a control signal when the remaining amount of the protective glue in the glue supplying tank reaches a predetermined lower bound, said control signal being used to open the pressure valve and the check valve such that the glue storing tank furnishes the glue supplying tank with the protective glue; and the second sensor is utilized for detecting the remaining amount of the protective glue in the glue supplying tank and sending another control signal when the remaining amount of the protective glue in the glue supplying tank reaches a predetermined upper bound, said another control signal being used to close the pressure valve and the check valve such that the glue storing tank stops furnishing the glue supplying tank with the protective glue.

In one embodiment of the present invention, at least one of the first sensor and the second sensor is a liquid level sensor that is utilized for detecting a liquid level of the protective glue in the glue supplying tank.

In one embodiment of the present invention, the glue applying system further comprises a third sensor and a fourth sensor. The third sensor is utilized for detecting a remaining amount of the protective glue in the glue storing tank and sending a control signal or alarm signal when the remaining amount of the protective glue in the glue storing tank reaches a predetermined lower bound, said control signal being used to control a feeding device to add the protective glue into the glue storing tank; and the fourth sensor is utilized for detecting the remaining amount of the protective glue in the glue storing tank and sending another control signal or alarm signal when the remaining amount of the protective glue in the glue storing tank reaches a predetermined upper bound, said another control signal being used to control the feeding device to stop adding the protective glue into the glue storing tank.

In one embodiment of the present invention, the check valve connects to the glue supplying tank and the glue storing tank via a glue supplying pipe and the glue supplying pipe connects to a bottom of the glue supplying tank.

The present invention also provides another glue applying system. Said glue applying system comprises a spray gun for spreading protective glue, characterized in that said system further comprises:

a glue supplying tank for supplying the protective glue to the spray gun;

a glue storing tank for furnishing the glue supplying tank with the protective glue; and

a check valve connecting to the glue supplying tank and the glue storing tank, for controlling the protective glue in the glue storing tank to flow into the glue supplying tank unidirectionally.

In one embodiment of the present invention, the glue applying system further comprises a pressure valve used for controlling gas introduced to the glue storing tank when the glue storing tank furnishes the glue supplying tank with the protective glue.

In one embodiment of the present invention, the glue applying system further comprises a first sensor and a second sensor. The first sensor is utilized for detecting a remaining amount of the protective glue in the glue supplying tank and sending a control signal when the remaining amount of the protective glue in the glue supplying tank reaches a predetermined lower bound, said control signal being used to open the pressure valve and the check valve such that the glue storing tank furnishes the glue supplying tank with the protective glue; and the second sensor is utilized for detecting the remaining amount of the protective glue in the glue supplying tank and sending another control signal when the remaining amount of the protective glue in the glue supplying tank reaches a predetermined upper bound, said another control signal being used to close the pressure valve and the check valve such that the glue storing tank stops furnishing the glue supplying tank with the protective glue.

In one embodiment of the present invention, the glue applying system further comprises a third sensor and a fourth sensor. The third sensor is utilized for detecting a remaining amount of the protective glue in the glue storing tank and sending a control signal or alarm signal when the remaining amount of the protective glue in the glue storing tank reaches a predetermined lower bound, said control signal being used to control a feeding device to add the protective glue into the glue storing tank; and the fourth sensor is utilized for detecting the remaining amount of the protective glue in the glue storing tank and sending another control signal or alarm signal when the remaining amount of the protective glue in the glue storing tank reaches a predetermined upper bound, said another control signal being used to control the feeding device to stop adding the protective glue into the glue storing tank.

In one embodiment of the present invention, the check valve connects to the glue supplying tank and the glue storing tank via a glue supplying pipe and the glue supplying pipe connects to a bottom of the glue supplying tank.

The present invention also provides a glue applying method, utilized in a glue applying system which comprises a glue supplying tank, a check valve, and a glue storing tank, said method comprising steps of:

opening the check valve when a detected remaining amount of protective glue in the supplying tank reaches a predetermined lower bound; and

furnishing the glue supplying tank with the protective glue in the glue storing tank via the check valve.

In one embodiment of the present invention, the step of opening the check valve when the detected remaining amount of the protective glue in the supplying tank reaches the predetermined lower bound comprises sub-steps of:

detecting a remaining amount of the protective glue in the glue supplying tank by using a first sensor;

sending a control signal to a pressure valve by the first sensor when the detected remaining amount of the protective glue in the supplying tank reaches the predetermined lower bound; and

opening the pressure valve and introducing gas to the glue storing tank to open the check valve.

In one embodiment of the present invention, the step of furnishing the glue supplying tank with the protective glue in the glue storing tank via the check valve comprises sub-steps of:

detecting the remaining amount of the protective glue in the glue supplying tank by using a second sensor;

sending another control signal to the pressure valve by the second sensor when the detected remaining amount of the protective glue in the glue supplying tank reaches a predetermined upper bound; and

closing the pressure valve so as to close the check valve and thereby the glue storing tank stops furnishing the glue supplying tank.

In one embodiment of the present invention, said method further comprises steps of:

detecting a remaining amount of the protective glue in the glue storing tank by using a third sensor; and

sending a control signal or alarm signal when the detected remaining amount of the protective glue in the glue storing tank reaches a predetermined lower bound, said control signal being used to control a feeding device to add the protective glue into the glue storing tank.

In one embodiment of the present invention, said method further comprises steps of:

detecting the remaining amount of the protective glue in the glue storing tank by using a fourth sensor; and

sending another control signal or alarm signal when the detected remaining amount of the protective glue in the glue storing tank reaches a predetermined upper bound, said another control signal being used to control the feeding device to stop adding the protective glue into the glue storing tank.

Compared to the conventional glue applying system and glue applying method, the glue applying system and the glue applying method provided in the present invention have both the glue storing tank and the glue supplying tank. The glue supplying tank is utilized for supplying the required protective glue to the spray gun. The glue storing tank is utilized for storing the protective glue and automatically furnishing the glue supplying tank with the protective glue when the protective glue in the glue supplying tank is consumed to an amount of lower bound. When the glue storing tank furnishes the glue supplying tank with the protective glue, the spray gun still can proceed with the coating operation. The procedure of adding the protective glue into the glue storing tank and the procedure of supplying the protective glue from the glue supplying tank are two independent procedures. Also, the procedure of adding the protective glue into the glue storing tank does not affect the coating operation proceeded by the spray gun. In the glue applying system and the glue applying method provided in the present invention, coating the protective glue and supplying the protective glue to the glue supplying tank and the glue storing tank can be proceed at the same time. The glue applying system does not have to stop the coating operation while furnishing with the protective glue. In addition, when furnishing the glue supplying tank with the protective glue in the technical schemes provided in the present invention, the protective glue is filled into the glue supplying tank from the bottom thereof in order to prevent from mixing the protective glue with air to carry a bubble therein. The filled protective glue will move upward such that the bubble that may be carried in the protective glue will be destroyed while moving to the liquid surface. It does not need to remove the bubble by hand.

### BRIEF DESCRIPTION OF THE DRAWINGS

The present invention will be described in details in conjunction with the appending drawings.

FIG. 1 is a schematic diagram showing a conventional glue applying system having two glue storing tanks.

FIG. 2 is a schematic diagram showing a glue applying system in accordance with a first preferred embodiment of the present invention.

FIG. 3 is a schematic diagram showing a glue applying system in accordance with a second preferred embodiment of the present invention.

FIG. 4 is a schematic diagram showing a glue applying system in accordance with a third preferred embodiment of the present invention.

FIG. 5 is a flow chart of a glue applying method in accordance with a preferred embodiment of the present invention.

FIG. 6 is a flow chart of adding protective glue into a glue storing tank for a glue applying method in accordance with a preferred embodiment of the present invention.

### DETAILED DESCRIPTION OF THE INVENTION

The following descriptions for the respective embodiments are specific embodiments capable of being implemented for illustrations of the present invention with referring to appended figures. For example, the terms of up, down, front, rear, left, right, interior, exterior, side, etcetera are merely directions of referring to appended figures.

Therefore, the wordings of directions are employed for explaining and understanding the present invention but not limitations thereto.

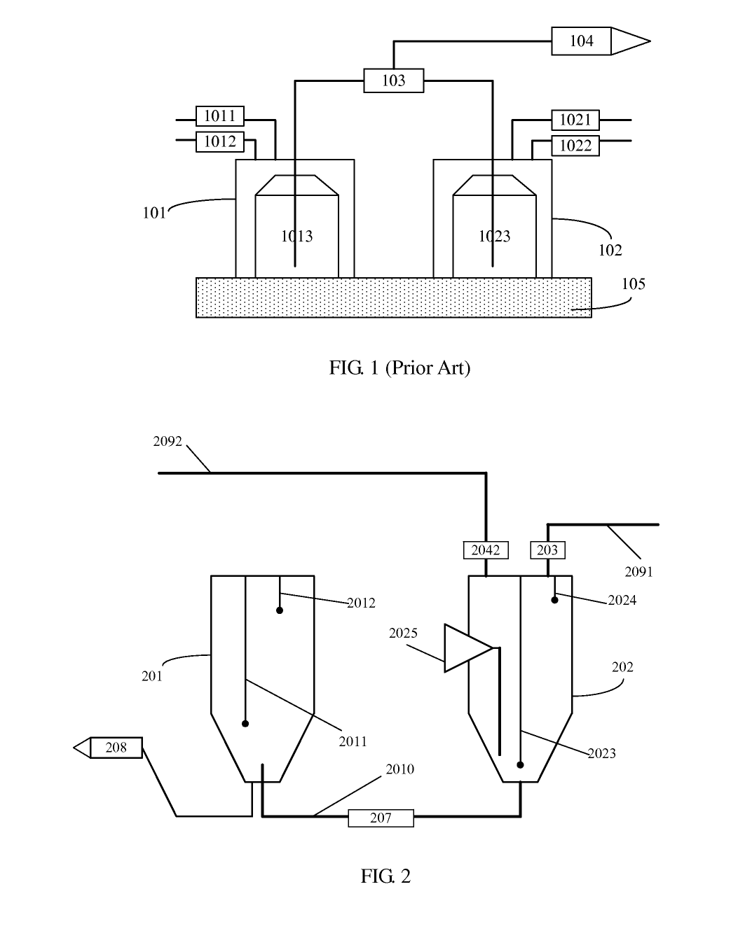

FIG. 2 is a schematic diagram showing a glue applying system in accordance with a first preferred embodiment of the present invention. The glue applying system of the first preferred embodiment comprises a glue supplying tank 201, a first sensor 2011 disposed in the glue supplying tank 201, a second sensor 2012 disposed in the glue supplying tank 201, a glue storing tank 202, a third sensor 2023 disposed in the glue storing tank 202, a fourth sensor 2024 disposed in the glue storing tank 202, a pressure valve 203, a second exhaust valve 2042, a check valve 207, and a spray gun 208.

The bottom of the glue storing tank 202 is connected to a glue supplying pipe 2010. The glue supplying pipe 2010 is then connected to the glue supplying tank 201 via the check valve 207. The glue supplying pipe 2010 enters the glue supplying tank 201 from the bottom thereof. The exit of the glue supplying pipe 2010 inside the glue supplying tank 201 is slightly higher than the bottom of the glue supplying tank 201. When protective glue flows from the glue storing tank 202 to the glue supplying tank 201 via the check valve 207, the protective glue is filled into the glue supplying tank 201 from the bottom thereof in order to prevent from mixing the protective glue with air to carry a bubble therein. The filled protective glue will move upward such that the bubble that may be carried in the protective glue will be destroyed while moving to the liquid surface. Therefore, it does not need to remove the bubble by hand.

The glue storing tank 202 is connected to the glue supplying tank 201 via the check valve 207. The check valve 207 allows the protective glue to flow through it in only one direction. Only the protective glue in the glue storing tank 202 can flow into the glue supplying tank 201 and the reverse flow is not permitted. The glue storing tank 202 also has a feeding port 2025 disposed thereon. The protective glue is added to the glue storing tank 202 from the feeding port 2025.

The pressure valve 203 is connected to the glue storing tank 202 via an air-intake pipe 2091. When the pressure valve 203 is opened, gas will be introduced to the glue storing tank 202 via the air-intake pipe 2091. The second exhaust valve 2042 is connected to the glue storing tank 202 via an exhaust pipe 2092. The second exhaust valve 2042 is utilized for releasing the gas in the glue storing tank 202.

The working principle of the glue applying system provided in the present invention is described as below.

The glue supplying tank 201 supplies the protective glue to the spray gun 208 when the glue applying system is working. The first sensor 2011 is utilized for detecting the remaining amount of the protective glue in the glue supplying tank 201. The first sensor 2011 sends a control signal to open the pressure valve 203 when the detected remaining amount of the protective glue in the glue supplying tank 201 is lower than a predetermined lower bound. After the pressure valve 203 is opened, gas is introduced to the glue storing tank 202 via the air-intake pipe 2091. The pressure in the glue storing tank 202 is increased such that the check valve 207 is opened. In the meantime, the protective glue is furnished to the glue supplying tank 201 from the glue storing tank 202.

The second sensor 2012 is utilized for detecting the remaining amount of the protective glue in the glue supplying tank 201. When the detected remaining amount of the protective glue in the glue supplying tank 201 is higher than a predetermined upper bound, the second sensor 2012 sends another control signal to the pressure valve 203 and the second exhaust valve 2042. Said another control signal is used to close the pressure valve 203 and open the second exhaust valve 2042. After that, introducing the gas to the glue storing tank 202 is stopped and the gas in the glue storing tank 202 is released via the exhaust pipe 2092 by passing through the second exhaust valve 2042. The pressure in the glue storing tank 202 is decreased such that the check valve 207 is closed. In the meantime, the protective glue will not flow back to the glue storing tank 202. Furnishing the glue supplying tank 201 with the protective glue is completed at this stage.

To carry out the technical schemes provided in the invention, both the first sensor 2011 and the second sensor 2012 can be implemented by liquid level sensors that are utilized for detecting the liquid level of the protective glue in the glue supplying tank 201, and thereby obtaining the data of remaining amount of the protective glue.

The third sensor 2023 is utilized for detecting the remaining amount of the protective glue in the glue storing tank 202. The glue applying system sends an alarm signal when the detected remaining amount of the protective glue in the glue storing tank 202 is lower than a predetermined lower bound. In the meantime, the protective glue can be manually added into the glue storing tank 202 through the feeding port 2025. The protective glue also can be automatically added into the glue storing tank 202 through the feeding port 2025. The fourth sensor 2024 is utilized for detecting the remaining amount of the protective glue in the glue storing tank 202. The glue applying system sends another alarm signal to stop adding the protective glue into the glue storing tank 202 when the detected remaining amount of the protective glue in the glue storing tank 202 is higher than a predetermined upper bound.

To carry out the technical schemes provided in the invention, both the third sensor 2023 and the fourth sensor 2024 can be implemented by liquid level sensors that are utilized for detecting the liquid level of the protective glue in the glue storing tank 202, and thereby obtaining the remaining amount of the protective glue in the glue storing tank 202.

In addition, when the glue storing tank 202 furnishes the glue supplying tank 201 with the protective glue, the third sensor 2023 also can send a control signal to the check valve 207 if the detected remaining amount of the protective glue in the glue storing tank 202 is lower than the predetermined lower bound. The control signal is used to close the check valve 207 such that the glue storing tank 202 stops furnishing the glue supplying tank 201 with the protective glue.

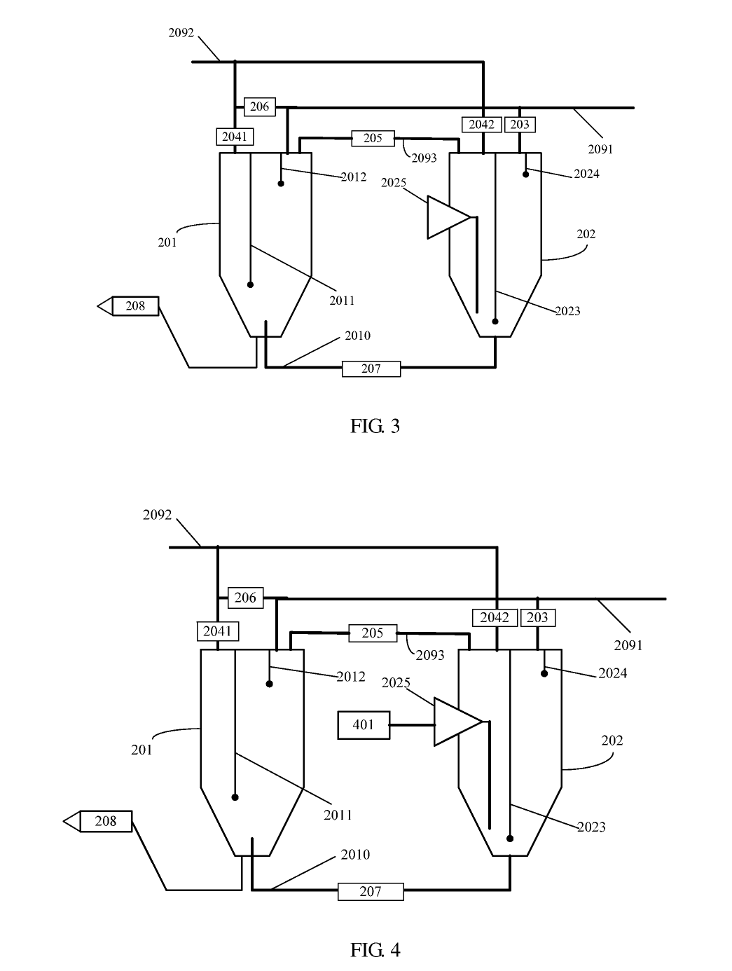

FIG. 3 is a schematic diagram showing a glue applying system in accordance with a second preferred embodiment of the present invention. The difference between the first preferred embodiment shown in FIG. 2 and the second preferred embodiment shown in FIG. 3 is that the glue applying system of the second preferred embodiment further comprises a first exhaust valve 2041, a pressure reducing valve 205, and an overflow valve 206.

The pressure reducing valve 205 is connected to the glue supplying tank 201 and the glue storing tank 202 via a communicating pipe 2093 for accommodating the pressure difference between the glue supplying tank 201 and the glue storing tank 202. In this manner, the pressure difference between the glue supplying tank 201 and the glue storing tank 202 can be maintained as a constant when the glue storing tank 202 furnishes the glue supplying tank 201 with the protective glue.

The first exhaust valve 2041 is connected to the glue supplying tank 201 via the exhaust pipe 2092 for releasing the gas in the glue supplying tank 201 when maintaining the glue applying system.

The overflow valve 206 is connected to the exhaust pipe 2092. The overflow valve 206 is utilized to ensure the pressure in the glue supplying tank 201 not exceeding a critical value. When the protective glue is filled into the glue supplying tank 201 and the pressure goes up to reach the critical value, the overflow valve 206 will be opened for maintaining the pressure in the glue supplying tank 201 stable.

The structure, function, and operating mechanism of other portions of the glue applying system provided in the second preferred embodiment of the present invention are the same as those of corresponding elements of the glue applying system provided in the first preferred embodiment of the present invention, and therefore are omitted herein.

FIG. 4 is a schematic diagram showing a glue applying system in accordance with a third preferred embodiment of the present invention. The difference between the second preferred embodiment shown in FIG. 3 and the third preferred embodiment shown in FIG. 4 is that the glue applying system of the third preferred embodiment further comprises an automatic feeding device 401. The automatic feeding device 401 is connected to the feeding port 2025 for adding the protective glue to the glue storing tank 202.

When the detected remaining amount of the protective glue in the glue storing tank 202 is lower than the predetermined lower bound, the third sensor 2023 sends a control signal to the automatic feeding device 401 such that the automatic feeding device 401 is activated according to the control signal and starts to feed the protective glue into the glue storing tank 202 through the feeding port 2025. The fourth sensor 2024 is utilized for detecting the remaining amount of the protective glue in the glue storing tank 202. When the detected remaining amount of the protective glue in the glue storing tank 202 is higher than the predetermined upper bound, the fourth sensor 2024 sends another control signal to the automatic feeding device 401 such that based on said another control signal, the automatic feeding device 401 stops feeding the protective glue to the glue storing tank 202.

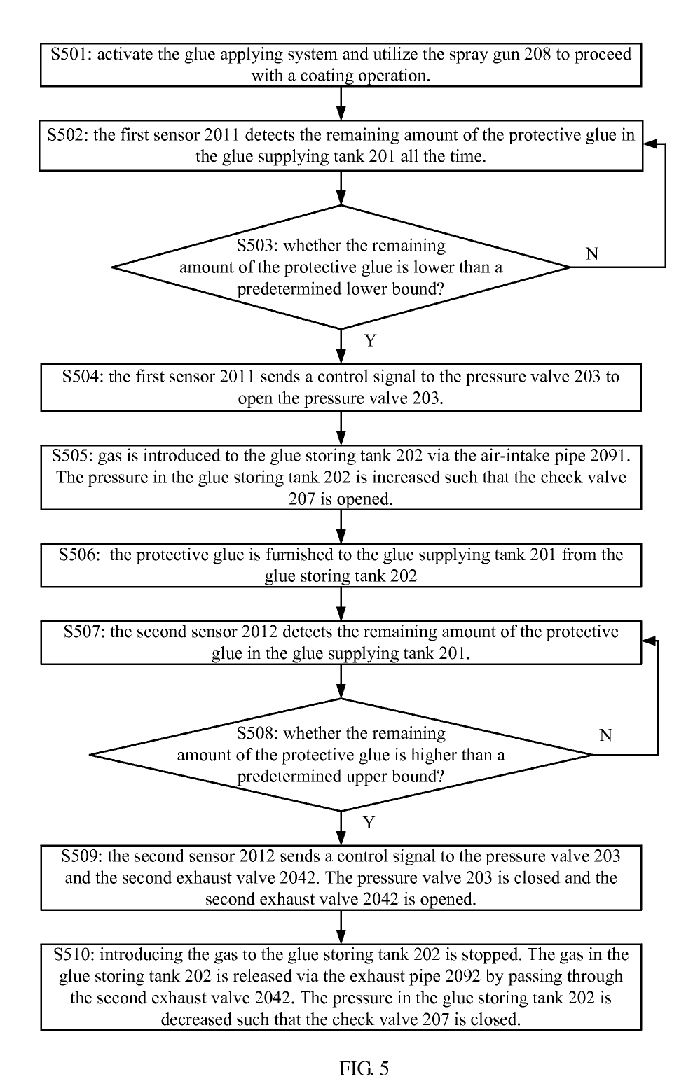

FIG. 5 is a flow chart of a glue applying method implemented in accordance with a preferred embodiment of the present invention. The glue applying method comprises steps described below.

Step S501: activate the glue applying system and utilize the spray gun 208 to proceed with a coating operation.

Step S502: the first sensor 2011 detects the remaining amount of the protective glue in the glue supplying tank 201 all the time.

Step S503: whether the detected remaining amount of the protective glue in the glue supplying tank 201 is lower than a predetermined lower bound? If yes, go to Step S504; or else, go to Step S502.

Step S504: the first sensor 2011 sends a control signal to the pressure valve 203 to open the pressure valve 203.

Step S505: gas is introduced to the glue storing tank 202 via the air-intake pipe 2091. The pressure in the glue storing tank 202 is increased such that the check valve 207 is opened.

Step S506: the protective glue is furnished to the glue supplying tank 201 from the glue storing tank 202.

Step S507: the second sensor 2012 detects the remaining amount of the protective glue in the glue supplying tank 201.

Step S508: whether the detected remaining amount of the protective glue in the glue supplying tank 201 is higher than a predetermined upper bound? If yes, go to Step S509; or else, go to Step S506.

Step S509: the second sensor 2012 sends a control signal to the pressure valve 203 and the second exhaust valve 2042. The pressure valve 203 is closed and the second exhaust valve 2042 is opened.

Step S510: introducing the gas to the glue storing tank 202 is stopped. The gas in the glue storing tank 202 is released via the exhaust pipe 2092 by passing through the second exhaust valve 2042. The pressure in the glue storing tank 202 is decreased such that the check valve 207 is closed.

Specifically, in Step S506, the pressure reducing valve 205 accommodates the pressure difference between the glue supplying tank 201 and the glue storing tank 202, such that the pressure difference between the glue supplying tank 201 and the glue storing tank 202 can be maintained as a constant.

In Step S506, the overflow valve 206 will be opened for maintaining the pressure in the glue supplying tank 201 stable if the pressure in the glue supplying tank 201 exceeds a critical value.

In Step S506, the third sensor 2023 will send a control signal to the check valve 207 if the detected remaining amount of the protective glue in the glue storing tank 202 is lower than a predetermined lower bound. The control signal is used to close the check valve 207 such that the glue storing tank 202 stops furnishing the glue supplying tank 201 with the protective glue.

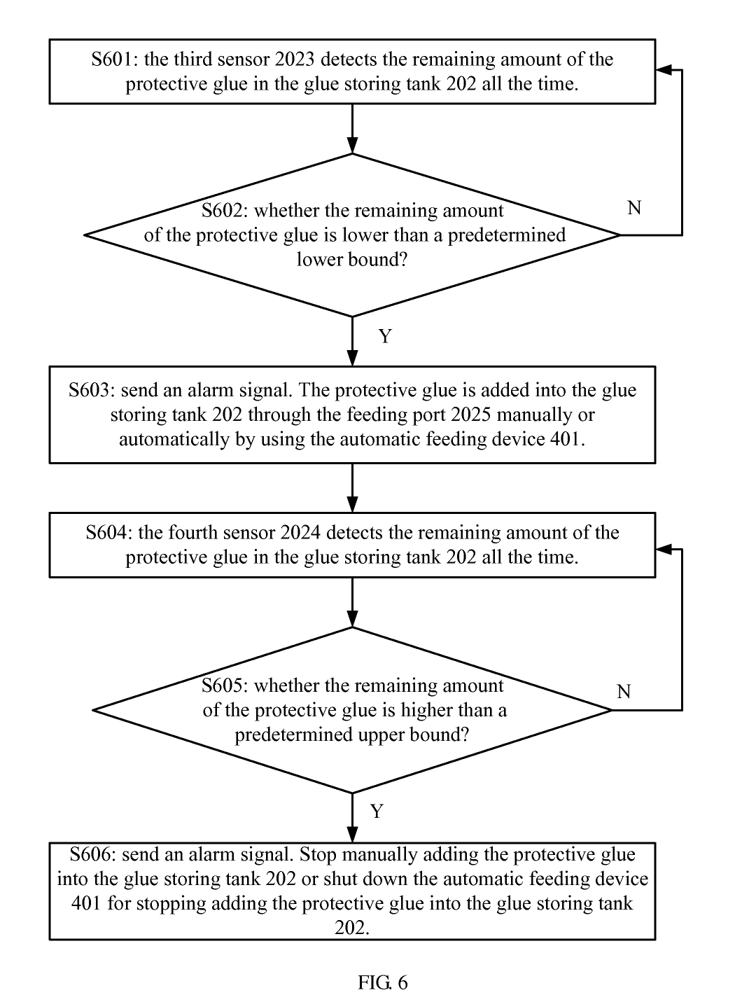

While performing the above steps, the glues applying method of the present invention also can simultaneously be executed to detect the remaining amount of the protective glue in the glue storing tank 202, and control the addition of the protective glue to the glue storing tank 202 based on the detected result, as shown in FIG. 6. The glue applying method further comprises steps described below.

Step S601: the third sensor 2023 detects the remaining amount of the protective glue in the glue storing tank 202 all the time.

Step S602: whether the detected remaining amount of the protective glue in the glue storing tank 202 is lower than a predetermined lower bound? If yes, go to Step S603; or else, go to Step S601.

Step S603: send an alarm signal. The protective glue is added into the glue storing tank 202 through the feeding port 2025 manually or automatically by using the automatic feeding device 401.

Step S604: the fourth sensor 2024 detects the remaining amount of the protective glue in the glue storing tank 202 all the time.

Step S605: whether the detected remaining amount of the protective glue in the glue storing tank 202 is higher than a predetermined upper bound? If yes, go to Step S606; or else, go to Step S604.

Step S606: send an alarm signal. Stop manually adding the protective glue into the glue storing tank 202 or shut down the automatic feeding device 401 for stopping adding the protective glue into the glue storing tank 202.

It is noted that in the glue applying system and the glue applying method of the embodiments of the present invention, no matter the glue storing tank furnishes the glue supplying tank with the protective glue or adding the protective glue into the glue storing tank, these procedures can be simultaneously performed while the glue applying system proceeds with the coating operation. The glue applying system does not have to stop the coating operation during the above procedures.

The glue applying system and the glue applying method provided in the present invention have both the glue storing tank and the glue supplying tank. The glue supplying tank is utilized for supplying the required protective glue to the spray gun. The glue storing tank is utilized for storing the protective glue and automatically furnishing the glue supplying tank with the protective glue when the protective glue in the glue supplying tank is consumed to an amount of lower bound. When the glue storing tank furnishes the glue supplying tank with the protective glue, the spray gun still can proceed with the coating operation. The procedure of adding the protective glue into the glue storing tank and the procedure of supplying the protective glue from the glue supplying tank are two independent procedures. Also, the procedure of adding the protective glue into the glue storing tank does not affect the coating operation proceeded by the spray gun. In the glue applying system and the glue applying method provided in the present invention, coating the protective glue and supplying the protective glue to the glue supplying tank and the glue storing tank can be proceed at the same time. The glue applying system does not have to stop the coating operation while furnishing with the protective glue.

In addition, when furnishing the glue supplying tank with the protective glue in the technical schemes provided in the present invention, the protective glue is filled into the glue supplying tank from the bottom thereof in order to prevent from mixing the protective glue with air to carry a bubble therein. The filled protective glue will move upward such that the bubble that may be carried in the protective glue will be destroyed while moving to the liquid surface.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A glue applying system, which comprises a spray gun for spreading protective glue, characterized in that said system further comprises:
a glue supplying tank for supplying the protective glue to the spray gun;
a glue storing tank for furnishing the glue supplying tank with the protective glue;
a check valve connecting to the glue supplying tank and the glue storing tank, for controlling the protective glue in the glue storing tank to flow into the glue supplying tank unidirectionally;
a pressure valve for controlling gas introduced to the glue storing tank when the protective glue in the glue storing tank unidirectionally flows into the glue supplying tank; and
a pressure reducing valve connecting to the glue supplying tank and the glue storing tank, for accommodating a pressure difference between the glue supplying tank and the glue storing tank, and maintaining the pressure difference between the glue supplying tank and the glue storing tank as a constant when the protective glue in the glue storing tank unidirectionally flows into the glue supplying tank.

2. The glue applying system according to claim 1, characterized in that said glue applying system further comprises:
a first sensor for detecting a remaining amount of the protective glue in the glue supplying tank and sending a control signal when the remaining amount of the protective glue in the glue supplying tank reaches a predetermined lower bound, said control signal being used to open the pressure valve and the check valve such that the glue storing tank furnishes the glue supplying tank with the protective glue; and
a second sensor for detecting the remaining amount of the protective glue in the glue supplying tank and sending another control signal when the remaining amount of the protective glue in the glue supplying tank reaches a predetermined upper bound, said another control signal being used to close the pressure valve and the check valve such that the glue storing tank stops furnishing the glue supplying tank with the protective glue.

3. The glue applying system according to claim 2, characterized in that at least one of the first sensor and the second sensor is a liquid level sensor that is utilized for detecting a liquid level of the protective glue in the glue supplying tank.

4. The glue applying system according to claim 1, characterized in that said glue applying system further comprises:
a third sensor for detecting a remaining amount of the protective glue in the glue storing tank and sending a control signal or alarm signal when the remaining amount of the protective glue in the glue storing tank reaches a predetermined lower bound, said control signal being used to control a feeding device to add the protective glue into the glue storing tank; and
a fourth sensor for detecting the remaining amount of the protective glue in the glue storing tank and sending another control signal or alarm signal when the remaining amount of the protective glue in the glue storing tank reaches a predetermined upper bound, said another control signal being used to control the feeding device to stop adding the protective glue into the glue storing tank.

5. The glue applying system according to claim 1, characterized in that the check valve connects to the glue supplying tank and the glue storing tank via a glue supplying pipe and the glue supplying pipe connects to a bottom of the glue supplying tank.

6. A glue applying system, which comprises a spray gun for spreading protective glue, characterized in that said system further comprises:
a glue supplying tank for supplying the protective glue to the spray gun;
a glue storing tank for furnishing the glue supplying tank with the protective glue; and
a check valve connecting to the glue supplying tank and the glue storing tank, for controlling the protective glue in the glue storing tank to flow into the glue supplying tank unidirectionally.

7. The glue applying system according to claim 6, characterized in that said glue applying system further comprises a pressure valve used for controlling gas introduced to the glue storing tank when the glue storing tank furnishes the glue supplying tank with the protective glue.

8. The glue applying system according to claim 7, characterized in that said glue applying system further comprises:
a first sensor for detecting a remaining amount of the protective glue in the glue supplying tank and sending a control signal when the remaining amount of the protective glue in the glue supplying tank reaches a predetermined lower bound, said control signal being used to open the pressure valve and the check valve such that the glue storing tank furnishes the glue supplying tank with the protective glue; and
a second sensor for detecting the remaining amount of the protective glue in the glue supplying tank and sending another control signal when the remaining amount of the protective glue in the glue supplying tank reaches a predetermined upper bound, said another control signal being used to close the pressure valve and the check valve such that the glue storing tank stops furnishing the glue supplying tank with the protective glue.

9. The glue applying system according to claim 6, characterized in that said glue applying system further comprises:
a third sensor for detecting a remaining amount of the protective glue in the glue storing tank and sending a control signal or alarm signal when the remaining amount of the protective glue in the glue storing tank reaches a predetermined lower bound, said control signal being used to control a feeding device to add the protective glue into the glue storing tank; and
a fourth sensor for detecting the remaining amount of the protective glue in the glue storing tank and sending another control signal or alarm signal when the remaining amount of the protective glue in the glue storing tank reaches a predetermined upper bound, said another control signal being used to control the feeding device to stop adding the protective glue into the glue storing tank.

10. The glue applying system according to claim 6, characterized in that the check valve connects to the glue supplying tank and the glue storing tank via a glue supplying pipe and the glue supplying pipe connects to a bottom of the glue supplying tank.

11. A glue applying method, utilized in a glue applying system which comprises a glue supplying tank, a check valve, and a glue storing tank, said method comprising steps of:
opening the check valve when a detected remaining amount of protective glue in the supplying tank reaches a predetermined lower bound; and
furnishing the glue supplying tank with the protective glue in the glue storing tank via the check valve.

12. The glue applying method according to claim 11, characterized in that the step of opening the check valve when the detected remaining amount of the protective glue in the supplying tank reaches the predetermined lower bound comprises sub-steps of:
detecting a remaining amount of the protective glue in the glue supplying tank by using a first sensor;
sending a control signal to a pressure valve by the first sensor when the detected remaining amount of the protective glue in the supplying tank reaches the predetermined lower bound; and
opening the pressure valve and introducing gas to the glue storing tank to open the check valve.

13. The glue applying method according to claim 11, characterized in that the step of furnishing the glue supplying tank with the protective glue in the glue storing tank via the check valve comprises sub-steps of:
detecting the remaining amount of the protective glue in the glue supplying tank by using a second sensor;
sending another control signal to the pressure valve by the second sensor when the detected remaining amount of the protective glue in the glue supplying tank reaches a predetermined upper bound; and
closing the pressure valve so as to close the check valve and thereby the glue storing tank stops furnishing the glue supplying tank.

14. The glue applying method according to claim 11, characterized in that said glue applying method further comprises steps of:
detecting a remaining amount of the protective glue in the glue storing tank by using a third sensor; and
sending a control signal or alarm signal when the detected remaining amount of the protective glue in the glue storing tank reaches a predetermined lower bound, said control signal being used to control a feeding device to add the protective glue into the glue storing tank.

15. The glue applying method according to claim 11, characterized in that said glue applying method further comprises steps of:
detecting the remaining amount of the protective glue in the glue storing tank by using a fourth sensor; and
sending another control signal or alarm signal when the detected remaining amount of the protective glue in the glue storing tank reaches a predetermined upper bound, said another control signal being used to control the feeding device to stop adding the protective glue into the glue storing tank.
